(19) United States
(12) Patent Application Publication
(10) Pub. No.: US 2020/0039373 A1
(43) Pub. Date: Feb. 6, 2020

(54) SYSTEMS AND METHODS FOR CHARGING AN UNMANNED AERIAL VEHICLE WITH A HOST VEHICLE

(71) Applicant: Walmart Apollo, LLC, Bentonville, AR (US)

(72) Inventors: Robert L. Cantrell, Herndon, VA (US); Donald R. High, Noel, MO (US); Brian G. McHale, Chadderton Oldham (GB); David J. Schuhardt, Montara, CA (US)

(21) Appl. No.: 16/530,510

(22) Filed: Aug. 2, 2019

Related U.S. Application Data
(60) Provisional application No. 62/713,886, filed on Aug. 2, 2018.

(51) Int. Cl. B60L 53/38; H02J 7/02; H02J 50/20; H02J 7/00; B64C 39/02; B60L 53/12; B60L 53/31; B60L 53/36

(52) U.S. Cl. CPC B60L 53/38; H02J 7/025; H02J 50/20; H02J 7/0045; B64C 39/024; B60L 2200/10; B60L 53/31; B60L 53/36; B64C 2201/042; B64C 2201/141; B60L 53/12

(57) ABSTRACT

Systems, apparatuses, and methods are provided herein for charging an unmanned aerial vehicle (UAV) in flight. A method comprises controlling motions of a UAV via a locomotion system, wherein the UAV comprises a charging antenna coupled to and extending away from a body of the UAV, the charging antenna comprises a wireless charge receiver positioned along a length of the charging antenna and a contact charge tip positioned at an end of the charging antenna away from the body. The UAV is configured to hover near the wireless charger of the host vehicle to charge a power storage device of the UAV via the charging antenna of the charging antenna and cause the contact charge tip of the charging antenna to contact the contact charge surface of the host vehicle to charge the power storage device while hovering.

### CROSS-REFERENCE TO RELATED APPLICATION

This application claims the benefit of U.S. Provisional Application No. 62/713,886, filed Aug. 2, 2018, which is incorporated herein by reference in its entirety.

### TECHNICAL FIELD

This invention relates generally to unmanned aerial vehicles.

### BACKGROUND

An unmanned vehicle generally refers to a motored vehicle without a human driver or pilot onboard. An unmanned aerial vehicle can be controlled to perform deliveries and are generally charged between trips.

### BRIEF DESCRIPTION OF THE DRAWINGS

Disclosed herein are embodiments of apparatuses and methods for charging an unmanned aerial vehicle (UAV). This description includes drawings, wherein:

FIG. 1 is an illustration of a system in accordance with several embodiments;

FIG. 2 is a block diagram of a system in accordance with several embodiments;

FIG. 3 is a flow diagram of a method in accordance with several embodiments; and

FIG. 4 is a flow diagram of a method in accordance with several embodiments;

FIG. 5 is an illustration of a contact charge surface and charging antennas in accordance with several embodiments;

FIG. 6 is an illustration of a UAV in accordance with several embodiments;

FIG. 7 is an illustration of a UAV in accordance with several embodiments; and

FIG. 8 is an illustration of a UAV in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for a system for charging an unmanned aerial vehicle (UAV) in flight. The system comprises a body of a UAV, a power storage device, a locomotion system, a communication device configured to communicate with host vehicles, a charging antenna coupled to and extending away from the body of the UAV, the charging antenna comprises a wireless charge receiver positioned along a length of the charging antenna and a contact charge tip positioned at an end of the charging antenna away from the body, and a control circuit of the UAV coupled to the locomotion system and the communication device. The control circuit being configured to establish communication with a host vehicle having a wireless charger and a contact charge surface, drive the locomotion system to hover near the wireless charger of the host vehicle to charge the power storage device via the charging antenna of the charging antenna, detecting for a travel condition with a sensor system, determine whether the travel condition meets a contact charge condition based on the communication with the host vehicle, and in the event that the travel condition meets the contact charge condition, drive the locomotion system to cause the contact charge tip of the charging antenna to contact the contact charge surface of the host vehicle to charge the power storage device while hovering.

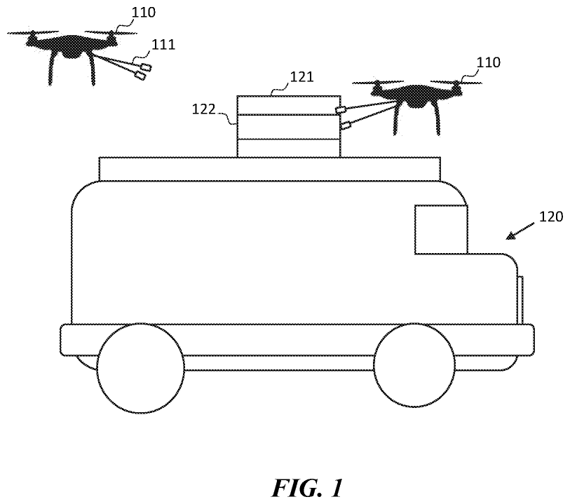

Referring now to FIG. 1, a UAV charging system according to some embodiments is shown. The system includes one or more unmanned aerial vehicles 110 and a host vehicle 120. In some embodiments, the system may comprise a plurality of host vehicles and other types of mobile and stationary charger devices.

An unmanned aerial vehicle (UAV) 110 may comprise an aerial vehicle configured to travel, perform tasks, and response to travel conditions without a human driver/pilot onboard. The UAV 110 comprises one or more charging antennas 111. In some embodiments, the UAV 110 further comprises a control circuit, a memory, a sensor system, a locomotion system, and a communication device. In some embodiments, the UAV 110 may comprise one or more parts of a conventional UAV. In some embodiments, a UAV 110 may be configured to follow the host vehicle 120 while the host vehicle 120 is traveling to receive over-the-air wireless charging and contact charging while the UAV 110 is in flight. In some embodiments, the UAV 110 and/or the host vehicle 120 may be configured to select between the two methods of charging (over-the-air and direct contact) based on travel conditions. In some embodiments, the UAV 110 may also be configured to land on the host vehicle 120 to recharge its battery. In some embodiments, the UAV 110 is configured to communicate with the host vehicle 120 to determine whether to approach for wireless charging and/or direct contact charging. The charging antenna 111 may be coupled to and extend away from the body of the UAV 110. In some embodiments, the charging antenna 111 comprises a wireless charge receiver positioned along a length of the charging antenna and a contact charge tip positioned at an end of the charging antenna away from the body. While FIG. 1 shows each of the UAVs 110 having two charging antennas extending away from the body of the UAV, charging antennas may be variously configured. For example, a UAV may comprise a single antenna having two prongs for contact charging. In another example, a UAV may comprise three or more antennas extending in different directions. In some embodiments, a UAV further comprises an additional prong or antenna for electrically grounding the UAV. Examples of charging antennas according to some embodiments are described in further detail with reference to FIGS. 6-8 wherein. In some embodiments, the UAV 110 may further comprise a package carrier configured to hold a package while receiving charge from a host vehicle that is traveling from one location to another.

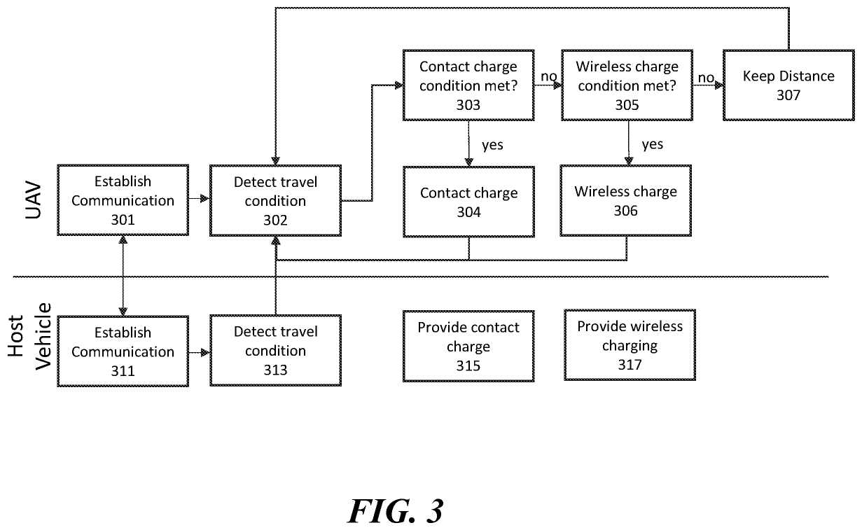

In some embodiments, the UAVs 110 and the host vehicle 120 may comprise vehicles traveling in a swarm or a pod for at least a segment of the route to their respective destinations. While an aerial vehicle is shown in FIG. 1, in some embodiments, the system may be configured to charge one or more of a UAV, an unmanned ground vehicle (UGV), an autonomous vehicle, a self-driving vehicle, a passenger vehicle, a cargo vehicle, etc. using the wireless charger. In some embodiments, the vehicle being charged may comprise a vehicle with autonomous, semi-autonomous, remotely piloted, and/or manual modes. In some embodiments, the UAV 110 may be configured to perform one or more steps described with reference to FIGS. 3-8 herein.

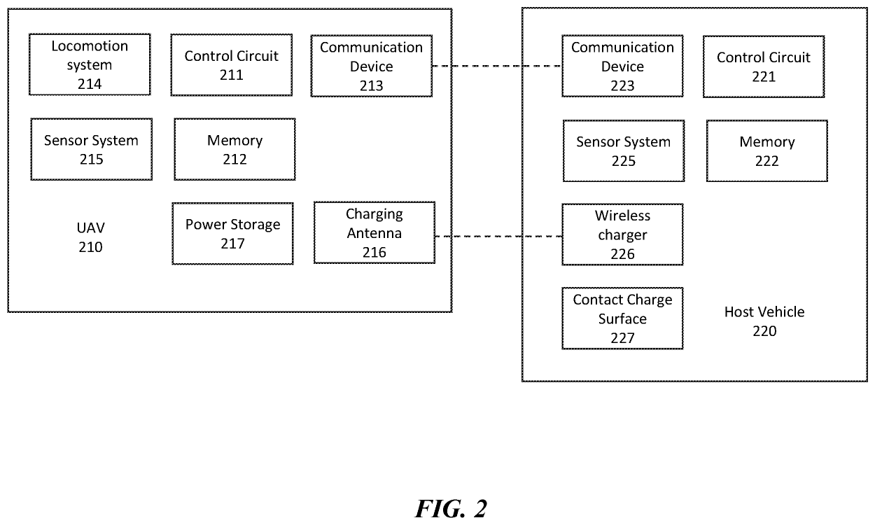

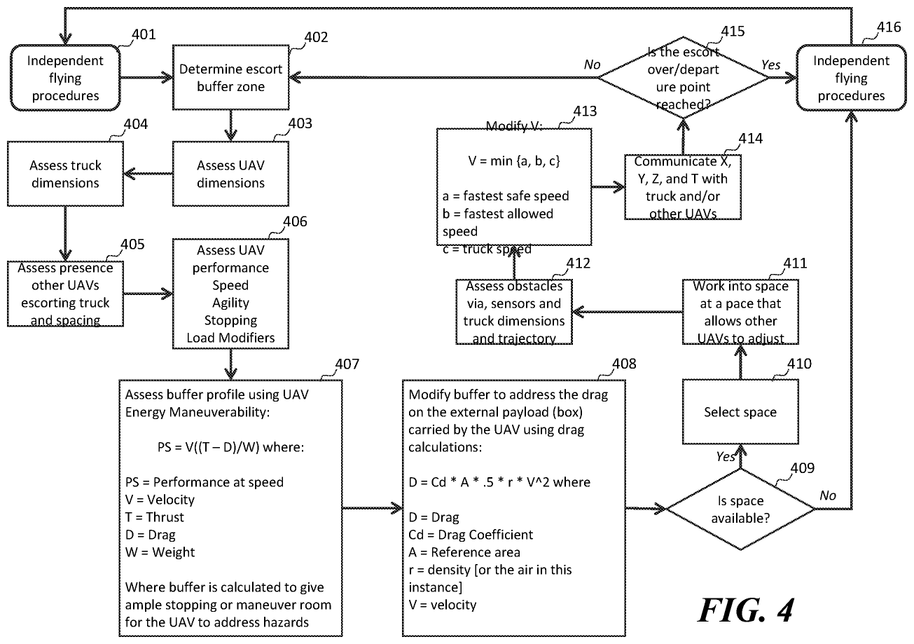

The host vehicle 120 comprises a vehicle with a charger system 121. In some embodiments, the host vehicle 120 may comprise a UGV configured to travel, perform tasks, and respond to travel conditions without a human driver/pilot on board. In some embodiments, the host vehicle 120 may be a conventional manned vehicle comprising components of a typical car or truck. In some embodiments, the host vehicle 120 may be a vehicle dedicated to supporting UAVs and may travel to various locations based on the tasks associated with the UAVs. In some embodiments, the host vehicle 120 may comprise one or more of an unmanned watercraft, a self-driving vehicle, a manned vehicle, a conventional ground vehicle, a cargo vehicle, a cargo truck, etc. In some embodiments, the host vehicle 120 may comprise a vehicle with autonomous, semi-autonomous, remotely piloted, and/or manual modes. In some embodiments, a host vehicle 120 may be configured to provide power to the UAV 110 and/or other types of vehicles. In some embodiments, the host vehicle 120 may be configured to provide wireless and contact charging to an airborne UAV 110. In some embodiments, the host vehicle 120 may further be configured to provide travel information and/or sensor readings to the UAV 110 to assist or direct the navigation of the UAV 110. An example of the host vehicle 120 is described with reference to FIG. 2 herein. In some embodiments, the host vehicle 120 may be configured to perform one or more steps described with reference to FIGS. 3-4 herein.

The host vehicle 120 comprises a charger system 121. The charger system 121 generally comprises a wireless charger and a contact charge surface 122. In some embodiments, the wireless charger may comprise one or more of an induction coil, an electromagnetic field generator, a radio frequency transmitter, and the like. Generally, the wireless charger may comprise any device configured to transmit/emanate energy configured to be collected by a wireless charge receiver at a distance without directly contacting the charger system 121. The contact charge surface 122 comprises an area of conductive material that, when contacted by the charging antenna 111 of a UAV 110, transfers energy to the power storage device of the UAV 110. In some embodiments, the contact charge surface 122 may comprise a positive region and a negative region providing a voltage differential between the regions. In some embodiments, the contact charge surface 122 may further comprise a ground region for electrically grounding the device being charged. In some embodiments, the contact charge surface 122 may be protected by a retractable cover that may cover surface when the contact charger is not in use and/or during severe weathers. In some embodiments, the wireless charger and the contact charge surface 122 may be implemented as a single charger assembly. In some embodiments, the contact charge surface 122 may comprise exposed coil(s) of the wireless charger. While the charger system 121 is shown to be installed on top of the host vehicle 120, in some embodiments, the charger system 121 may be implemented on other locations of the host vehicle. For example, the charger system may be integrated into the form factor of the vehicle such that the wireless charger is carried in the interior of the host vehicle 120 and the contact charge surface 122 is integrated with an exterior surface of the body of the host vehicle 120. In another example, a supporting structure may hold the charger system 121 a short distance away from the body of the host vehicle 120 above, behind, or to one side of the host vehicle 120. In some embodiments, wireless charger and the contact charge surface 122 may be separately implemented on the host vehicle. For example, the wireless charger may be implemented on the roof of the vehicle while the contact charge surface 122 may be implemented on the sides of the vehicle. In some embodiments, multiple contact charge surfaces 122 may be positioned at different locations of the host vehicle 120.

While two UAVs are shown in FIG. 1, one host vehicle may simultaneously provide charge and/or navigation instructions to any number of UAVs 110. In some embodiments, any number of UAVs may follow the same host vehicle. In some embodiments, a UAV 110 may be configured to receive charge from different host vehicles and/or stationary charge stations. In some embodiments, a plurality of UAVs 110 and/or host vehicles 120 may form a swarm that travels together for at least a segment of each devices' journey. In some embodiments, vehicles in a swarm may share sensor data and/or location for avoiding obstacles and each other. In some embodiments, vehicles in a swarm may selectively break off from the swarm to perform individual tasks and/or travel in a different direction.

Referring now to FIG. 2, a system comprising a UAV 210 and a host vehicle 220 according to some embodiments is shown. In some embodiments, the UAV 210 may comprise a UAV 110 described with reference to FIG. 1 or a similar device. In some embodiments, the host vehicle 220 may comprise the host vehicle 120 described with reference to FIG. 1 or a similar device.

The UAV 210 may comprise an aerial vehicle configured to travel and perform a variety of tasks. In some embodiments, the UAV 210 may comprise a verticle lift aerial vehicle such as a bicopter, a tricopter, a quadcopter, a hexacopter, an octocopter, etc. In some embodiments, the UAV 210 may be autonomous, semi-autonomous, and/or remotely piloted. In some embodiments, the UAV 210 may be configured to carry persons, packages, and/or other types of cargo.

The UAV 210 comprises a control circuit 211, a memory 212, a communication device 213, a locomotion system 214, a sensor system 215, a charging antenna 216, and a power storage device 217. The control circuit 211 may comprise a processor, a microprocessor, an application specific integrated circuit (ASIC) and the like and may be configured to execute computer readable instructions stored on a computer-readable storage memory 212. The control circuit 211 may be communicatively coupled to one or more of the memory 212, the communication device 213, the locomotion system 214, the sensor system 215, the charging antenna 216, and the power storage device 217. The computer-readable storage memory 212 may comprise volatile and/or non-volatile memory and have stored upon it a set of computer readable instructions which, when executed by the control circuit 211, causes the control circuit 211 to navigate the UAV 210 and communicate with other devices. Generally, the control circuit 211 may be configured to control the locomotion system 214 to navigate the UAV 210 based on sensor data from the sensor system 215 and perform various tasks. The control circuit 211 may be configured to communicate with the host vehicle 220 to receive navigation instructions to charge the power storage device 217 of the UAV 210 via the charging antenna 216. In some embodiments, the control circuit 211 executing codes stored on the memory 212 may perform one or more steps described with reference to FIGS. 3-4 herein.

The communication device 213 may generally comprise a signal transceiver that allows the control circuit 211 to communicate with another device such as the host vehicle 220, another UAV, and/or a central server device. In some embodiments, the communication device 213 may comprise one or more of a WLAN transceiver, a WWAN transceiver, a mobile data network transceiver, a satellite network transceiver, a WiMax transceiver, a Wi-Fi transceiver, a Bluetooth transceiver, a wireless beacon and the like. In some embodiments, the communication device 213 may be configured to form a peer-to-peer network with the host vehicle 220 and/or other vehicles traveling nearby. In some embodiments, vehicles in a swarm may form a wireless local area network for communications. In some embodiments, the UAV 210 may receive task assignments, navigation instructions, and/or sensor data through the communication device 213. In some embodiments, the UAV 210 may be configured to autonomously travel and perform tasks for extended periods of time (e.g. hours, days) without communicating with another vehicle, a central server, or the host vehicle 220.

The locomotion system 214 may comprise one or more motors that control the speed, direction, and/or orientation of the UAV 210. The locomotion system 214 may be configured to be controlled by the control circuit 211 to steer and drive the UAV 210 in designated directions and speed. In some embodiments, the locomotion system 214 may comprise locomotion systems such as rotors and/or propellers of a typical UAV.

The sensor system 215 may comprise one or more navigation and/or data collection sensors. In some embodiments, the sensor system 215 may comprise one or more location and/or obstacle sensors. In some embodiments, the sensor system 215 may comprise one or more of a magnetometer, an optical sensor, an accelerometer, a gyroscope, a GPS sensor, a virtual mapping processor, a Universal Transverse Mercator (UTM) tracker, and a laser range finder, an altitude sensor, and the like. In some embodiments, the sensor system 215 may further comprise one or more environmental sensors such as a wind sensor, a light sensor, an optical sensor, a visibility sensor, a weather sensor, a barometric pressure sensor, a range sensor, a humidity sensor, a sound sensor, a thermal image sensor, a night vision camera, etc. In some embodiments, the sensor system 215 may comprise sensors that are configured to detect obstacles and/or locate contact charge surfaces on the host vehicle 220.

The charging antenna 216 may comprise a device configured to receive electrical power to charge the power storage device 217 of the UAV 210 through both over-the-air wireless charging and direct electrical contact charging. In some embodiments, the charging antenna 216 is coupled to and extends away from the body of the UAV. In some embodiments, the charging antenna comprises a wireless charge receiver positioned along a length of the charging antenna and a contact charge tip positioned at an end of the charging antenna away from the body. Over-the-air wireless charging generally refers to power transfer without physical contact. In some embodiments, the wireless charge receiver of the charging antenna 216 may be configured to receive power at a distance of several inches or several feet from the wireless charger device of host vehicle 220. The contact charge tip generally refers to an exposed electrode configured to make physical contact with a contact charge surface on the host vehicle. In some embodiments, when the contact charge tip physically contacts the electrode of the contact charge surface 227 on the host vehicle 220, an electrical connection is formed via the two exposed electrodes for transfer of energy.

In some embodiments, the charging antenna comprises a flexible rod. In some embodiments, the charging antenna is configured to be extended and retracted by the control circuit. In some embodiments, the charging antenna is configured to be raised and lowered by the control circuit. In some embodiments, the contact charge tip comprises a metal brush that bends when in contact with a surface. In some embodiments, the contact charge tip comprises two spaced apart prongs for contacting positive and negative leads on a host vehicle.

The power storage device 217 may comprise a power storage device configured to store and supply power to one or more other components of the UAV 210. In some embodiments, the power storage device 217 may comprise a rechargeable battery such as one or more of, a lithium-ion battery, a lithium-ion polymer battery, a lead-acid battery, a nickel-cadmium battery, a nickel-metal hydride battery, a solid-state battery, and the like. In some embodiments, the UAV 210 may comprise other known UAV components such as an aerial crane, wings, landing gear, indicator lights, package carrier etc. that are omitted in FIG. 2 for simplicity.

A host vehicle 220 generally refers to a vehicle configured to provide charge to the UAV 210. In some embodiments, the host vehicle 220 may comprise the host vehicle 120 described with reference to FIG. 1 herein or similar devices. In some embodiments, the host vehicle 220 may comprise a ground vehicle, a watercraft, an aerial vehicle and the like. In some embodiments, the host vehicle 220 may be a cargo carrying vehicle or a vehicle dedicated to providing energy to UAVs. The host vehicle 220 comprises a control circuit 221, a memory 212, a communication device 223, a sensor system 225, a wireless charger 226, and a contact charge surface 227.

The control circuit 221 may comprise a processor, a microprocessor, an ASIC and the like and may be configured to execute computer readable instructions stored on a computer-readable storage memory 222. The control circuit 221 may be communicatively coupled to one or more of the memory 212, the communication device 223, the sensor system 225, the wireless charger 226, and the contact charge surface 227. The computer-readable storage memory 222 may comprise volatile and/or non-volatile memory and have stored upon it a set of computer readable instructions which, when executed by the control circuit 221, causes the control circuit 221 to communicate with the UAV 210 to provide wireless and direct contact charging. In some embodiments, the control circuit 221 may further provide navigation instructions to the UAV 210. In some embodiments, the control circuit 221 executing codes stored on the memory 222 may be configured to perform one or more steps described with reference to FIGS. 3-4 herein.

The communication device 223 may generally comprise a signal transceiver that allows the control circuit 221 to communicate with another device such as the UAV 210 and/or a central server device. In some embodiments, the communication device 223 may comprise one or more of a WLAN transceiver, a WWAN transceiver, a mobile data network transceiver, a satellite network transceiver, a WiMax transceiver, a Wi-Fi transceiver, a Bluetooth transceiver, and the like. In some embodiments, the communication device 223 may be configured to form a peer-to-peer network with a plurality of UAVs and/or other ground vehicles. In some embodiments, the control circuit 221 may use the communication device 223 to authenticate a UAV 210, exchange travel condition information, provide charging instructions, and/or provide flight control information to the UAV 210.

The wireless charger 226 may generally comprise a device configured to provide charge to another device without a wire connection. In some embodiments, the wireless charger 226 may be configured to provide charge via wireless contact charging and/or over-the-air charging. In some embodiments, the wireless charger 226 may comprise an inductive coil and/or a charging pad that sends out a radio frequency (RF) signal that can be collected as power over-the-air. In some embodiments, the wireless charger may comprise a loop configured to provide power to a UAV flying inside the loop. The contact charge surface 227 comprises an area of conductive material that, when contacted by the charging antenna 216 of a UAV 110, transfers energy to the power storage device 217 of the UAV 210. In some embodiments, the contact charge surface 227 may comprise a positive region and a negative region. In some embodiments, the contact charge surface 227 may further comprise a ground region. In some embodiments, the contact charge surface 227 may be protected by a retractable cover that may be lowered when the contact charger is not in use and/or during severe weathers. In some embodiments, the wireless charger 226 and the contact charge surface 227 may be implemented as a single charger system such as the charger system 121 described with reference to FIG. 1. In some embodiments, the coil of the wireless charger 226 may be exposed to simultaneously serve as a contact charge surface 227. In some embodiments, the wireless charger 226 and the contact charge surface 227 may be implemented at various locations of the host vehicle 220. For example, the wireless charger may be carried in the interior of the host vehicle 220 and the contact charge surface 227 may be integrated into an exterior surface of the host vehicle 120. In another example, a charger system may extend away from the body of the host vehicle above, behind, or two one side of the host vehicle with a supporting structure holding the charger system. In some embodiments, the wireless charger 226 and the contact charge surface 122 may be separately implemented on the host vehicle. For example, the wireless charger may be implemented on the roof of the vehicle while the contact charge surface 122 may be implemented on one or more sides of the vehicle. In some embodiments, the contact charge surface may further comprise a coupling device configured to attach to the UAV 210 while the UAV 210 is being charged while in-flight. In some embodiments, the coupling device may comprise mechanical and/or magnetic couplers. In some embodiments, the UAV 210 and/or the host vehicle 220 may be configured to selectively engage/disengage the coupling device based on travel conditions.

The sensor system 225 may comprise one or more navigation and/or data collection sensors. In some embodiments, the sensor system 225 may comprise one or more sensors for capturing data around the host vehicle 220, locating the host vehicle 220, and locating one or more UAVs 210. In some embodiments, the data collected by the sensor system 225 may be used to assist the UAV 210 in following the host vehicle 220 without colliding with the host vehicle, other UAVs following the host vehicles, and other obstacles. In some embodiments, the sensor system 225 may monitor the area around the host vehicle 220 to determine whether the condition is safe for a UAV 210 to approach and/or make contact for charging. In some embodiments, data collected by the sensor system 225 may be combined with the data collected by the sensor system 215 of the UAV 210 to determine the travel conditions of the host vehicle 220 and/or the UAV 210. In some embodiments, the sensor system 225 may include navigation sensors of the vehicle such as a magnetometer, an accelerometer, an altitude sensor, a gyroscope, radar, an optical sensor, and the like. In some embodiments, the sensor system 225 may comprise one or more environmental sensors such as a wind sensor, a light sensor, an optical sensor, a visibility sensor, a weather sensor, a barometric pressure sensor, a range sensor, a humidity sensor, a sound sensor, a thermal image sensor, a night vision camera, etc. In some embodiments, the sensor system may comprise a sensor grid of optical and/or acoustic sensors positioned around the host vehicle 220 that is configured to monitor the positions of one or more UAVs 210 flying near the host vehicle 220.

In some embodiments, the host vehicle 220 may comprise other components not shown. For example, a host vehicle 220 implemented on a UGV may comprise other UGV components such as a locomotion system, wheels, a chassis, and the like that are omitted in FIG. 2 for simplicity. In some embodiments, one or more of the sensor system 225, the wireless charger 226, and the contact charge surface 227 may be a separate device installed on a conventional vehicle and comprises a control circuit, memory and/or power supply separate from the control system of the vehicle itself.

Referring now to FIG. 3, a method of charging a UAV is shown. In some embodiments, the steps shown in FIG. 3 may be performed by two or more processor-based devices, such as the UAV 110 and the host vehicle 120 described with reference to FIG. 1, the UAV 210 and the host vehicle 220 described with reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a host vehicle, a processor of a charging station, and/or a processor device of a server system. In some embodiments, one or more steps in FIG. 3 may be performed collected by a plurality of UAVs and/or ground vehicles through distributed computing.

In steps 301 and 311, a UAV and a host vehicle establish communication. In some embodiments, the communication is established via the communication device 213 of the UAV 210 and the communication device 223 of the host vehicle 220 or similar devices. In some embodiments, the communication may comprise a private, peer-to-peer, encrypted, secured, and/or broadcasted communication channel. In some embodiments, the communication may be established via an intermediary server or a routing device. In some embodiments, communication may be established by the UAV joining a local area network of a vehicle swarm formed around the host vehicle. In some embodiments, steps 301 and 311 may comprise a cryptographic handshake. In some embodiments, the UAV may send a charge request to the host vehicle and provide a UAV identifier to obtain authorization to receive power. In some embodiments, the host vehicle may be configured to authenticate the UAV and determine whether the UAV is permitted to use the host vehicle at the requested time. In some embodiments, the host vehicle may determine whether the wireless charger and/or contact charge surface on the host vehicle is available for use based on one or more of the current usage, the predicted usage, and a travel conditions. In some embodiments, the host vehicle may monitor its surrounding to determine whether it is safe for the UAV to approach. For example, a host vehicle prevents the UAV from approaching if the vehicle is about to enter a tunnel or other low clearance area. In another example, the host vehicle may prevent the UAV from approaching if the number of UAV hovering near the host vehicle exceeds a capacity threshold. In some embodiments, the UAV may be configured to determine whether the conditions are safe for the approach. In some embodiments, if the wireless charger is not turned on, the host vehicle may be configured to supply power to the wireless charger and/or the contact charge surface after the UAV is authenticated/authorized to receive power. In some embodiments, the UAV may join a swarm comprising the host vehicle and UAVs following the host vehicle in step 301 and 311. In some embodiments, vehicles in a swarm may share location, sensor data, and/or planned travel path via a wireless network to coordinate their movements. In some embodiments, a swarm may comprise a host vehicle and the UAVs that are currently following the host vehicle. In some embodiments, steps 301 and 311 may be omitted. For example, the host vehicle may be a passive charge provider that does not authenticate the UAV, provide sensor data, or provide navigation instructions. In some embodiments, the communication between the host vehicle and the UAV may be established via a remote server prior to the UAV being in the vicinity of the host vehicle.

In step 302 and step 313 the UAV and the host vehicle detect for travel conditions. Travel conditions may generally refer to factors that affect the movement of the host vehicles and/or the UAV. In some embodiments, travel conditions may be detected by sensor systems on the host vehicle and/or UAV such as the sensor system 215 and the sensor system 225 described with reference to FIG. 2. In some embodiments, the host vehicle comprises the sensor system for detecting the travel conditions of the UAV and/or the host vehicle and communicates the travel conditions to the control circuit of the UAV. In some embodiments, travel conditions may be detected by one or more onboard sensors of the UAV. In some embodiments, travel conditions may comprise one or more of air drag, wind speed, precipitation, flight altitude, road condition, obstacles, planned travel path, traffic condition, presence of other UAVs, and the like. In some embodiments, step 302 or step 313 may be omitted. For example, travel conditions may be entirely determined by the sensor system of the host vehicle or the sensor system of the UAV. In some embodiments, travel conditions may further be determined based on sensor systems of other UAVs following the host vehicle and/or be retrieved from an external source such as a weather service or traffic condition service.

In step 303, the UAV determines whether a contact charge condition is met. In some embodiments, whether the contact charge condition is met is determined at least in part based on the travel condition detected in step 302 and/or step 313. In some embodiments, the system may determine the UAV's travel capabilities based on the travel condition and the UAV's specification. In some embodiments, whether the travel condition meets the contact charge condition is determined based on one or more of host vehicle speed, host vehicle path, clearance around the host vehicle, current drag, UAV speed, UAV acceleration capability, and UAV cargo weight. In some embodiments, the determination may be based at least in part on whether the UAV has the capability to keep up with the host vehicle while making contact with the contact charge surface of the host vehicle for at least a threshold duration (e.g. 30 second, 2 minutes, 5 minutes, etc.) In some embodiments, the determination may be based at least in part on whether sufficient clearance is present for the UAV to make contact with the contact charge surface for at least a threshold duration. In some embodiments, the determination may be based at least in part on the travel path of the host vehicle and the destination of the UAV and whether following the host vehicle would lead UAV in the right direction. In some embodiments, the determination may be based at least in part on assessing the risk of making contact with the host vehicle and whether a risk threshold is exceeded. In some embodiments, the contact charge condition may further depend on the current battery level of the UAV. For example, the UAV may increase the risk threshold if the battery is low. In some embodiments, the UAV may only make contact with the host vehicle if the host vehicle is stopped (e.g. at a red light) or traveling at a low speed. In some embodiments, the UAV may only make contact with the contact charge surface of the host vehicle if the contact charge surface is dry. An example of the determination is described with reference to FIG. 4 herein. In some embodiments, step 303 may be performed instead at the host vehicle and/or a remote server based on sensor data from the UAV and/or the host vehicle. For example, the UAV may send sensor data and UAV capability information to the host vehicle, and if the host vehicle determines that contact charge condition is met, the host vehicle may permit the UAV to approach. In some embodiments, the host vehicle may further assign the UAV a specific position around the host vehicle. In some embodiments, step 303 may be performed collectively by the UAV, the host vehicle, and/or other vehicles following the host vehicle.

If the contact charge condition is met in step 303, the UAV initiates contact charge in step 304 and the host vehicle provides contact charge in step 315. In some embodiments, the UAV may travel toward the host vehicle and orient a charging antenna to make contact with a contact surface on the host vehicle. In some embodiments, the contact charge surface may comprise optical markers that allow the UAV to locate the contact charge surface(s). In some embodiments, the host vehicle may first assign a charge position to the UAV and instruct the UAV to move into the assigned position relative to the host vehicle. In some embodiments, the host vehicle is configured to provide flight instructions to the locomotion system of the UAV via the communication device and the control circuit of the UAV to direct the UAV to the charge position and/or control the flight pattern of the UAV while the UAV is being charged.

If the contact charge condition is not met in step 303, the UAV further determines whether the wireless charge condition is met in step 305. In some embodiments, whether the wireless charge condition is met is determined based at least in part on the travel condition detected in step 302 and/or step 313. In some embodiments, the system may determine the UAV's flight capabilities based on the travel condition and the UAV's specification. In some embodiments, whether the travel condition meets the wireless charge condition is determined based on one or more of host vehicle speed, host vehicle path, clearance around the host vehicle, current drag, UAV speed, UAV acceleration capability, and UAV cargo weight. In some embodiments, the determination may be based at least in part on whether the UAV has the capability to keep up with the host vehicle and stay within a charge range of the wireless charger on the host vehicle. In some embodiments, the determination may be based at least in part on whether sufficient clearance is present for the UAV to travel within the range of the wireless charger. In some embodiments, the determination may be based at least in part on the travel path of the host vehicle and the destination of the UAV and whether following the host vehicle would lead UAV in the right direction. Generally, wireless charge condition may be more tolerant than the contact charge condition as contact charging would require the UAV to fly closer to the host vehicle with less room as a buffer. In some embodiments, the determination may be based at least in part on assessing the risk of entering the charge range of the host vehicle and whether a risk threshold is exceeded. In some embodiments, the wireless charge condition may further depend on the current battery level of the UAV. For example, the UAV may increase the risk threshold if the battery is low. An example of the determination is described with reference to FIG. 4 herein. In some embodiments, step 305 may be performed instead at the host vehicle and/or a remote server. In some embodiments, step 305 may be performed collectively by the UAV, the host vehicle, and/or other vehicles following the host vehicle.

If the wireless charge condition is met in step 305, the UAV initiates wireless charge in step 306 and the host vehicle provides over-the-air wireless charging in step 317. In some embodiments, the wireless charge receiver on the UAV is implemented on one or more charge antennas that extends away from the body of the UAV. In some embodiments, the one or more charge antennas may be retractable. In some embodiments, the UAV may be configured to orient at least one of the charge antennas towards the wireless charger of the host device to decrease the distance between the wireless charger and the wireless charge receiver of the UAV. In some embodiments, in step 306 the UAV may travel toward the host vehicle and into a charge range of the wireless charger. In some embodiments, the UAV may monitor the magnitude of the wireless charger signal to determine whether it is within the charger's range. In some embodiments, the wireless charger may comprise optical markers that allow the UAV to locate the wireless charger. In some embodiments, the host vehicle may first assign a charge position to the UAV and instruct the UAV to move into the assigned position relative to the host vehicle. In some embodiments, the host vehicle is configured to provide flight instructions to the locomotion system of the UAV via the communication device and the control circuit of the UAV. In some embodiments, the UAV may also join a swarm of other UAVs following the host vehicle in step 306.

In some embodiments, the host vehicle may keep one or more of the wireless charger or the contact charge surface turned on regardless of whether charge conditions are met. In some embodiments, the contact charger surface and/or the wireless charger may be already on to charge another UAV prior to the UAV establishing communication with the host vehicle in steps 301 and 311. In some embodiments, the contact charge surface may comprise a plurality of portions that may be individually turned on and off.

If the wireless charge condition is not met, in step 307, the UAV keep a distance from the host vehicle and no charge is received. In some embodiments, in step 307, the UAV may continue to follow the host vehicle at a distance. In some embodiments, in step 307, the UAV may fly away from the host vehicle.

After steps 304, 306, and/or 307 the system may return to steps 313 and/or 302. The system may continue to monitor for travel condition and reassess whether travel conditions met the contact charge condition in step 304 or the wireless charge condition in step 306. For example, the system may determine whether the travel condition meets the contact charge condition while the contact charge tip of the charging antenna is in contact with the contact charge surface of the host vehicle and, in the event that travel condition no longer meet the contact charge condition, cause to the locomotion system to move the charging antenna away from the contact charge surface of the host vehicle. In some embodiments, the conditions may be determined based on specific charge positions around the vehicle. For example, if one charge position no longer meets the contact charge position, the UAV may move into another charge position that meets the contact charge condition. Similar determination applies to wireless charge condition. In some embodiments, the UAV may further determine a separation location for separating from the host vehicle based on the routes of the UAV and the host vehicle. The UAV may fly away from the host vehicle when the separation location is reached.

While FIG. 3 shows steps 304 and 306 being performed by the UAV, in some embodiments, the host vehicle may determine whether the contact charge condition and/or wireless charge condition are met. For example, the host vehicle may use travel conditions collected by the UAV, the host vehicle, and/or other UAVs following the UAV to determine whether a charge position is available for the UAV to approach for contact or over-the-air charging. The host vehicle may then communicate the position to the UAV. In some embodiments, the host vehicle may further communication modified positions to other UAVs following the host vehicle to make room for the newly joined UAV. In some embodiments, the host vehicle may directly control the UAVs while the UAVs are being charged. For example, when the host vehicle is about to turn, slow down, or speed up, the UAV may cause the UAVs to do the same as to be able to continue to receive contact or wireless charging. In some embodiments, if a host vehicle detects a coming obstacle, the host vehicle may instruct the UAV to change position to avoid the obstacle. For example, if the host vehicle is entering a tunnel, the UAVs may be instructed to follow the host vehicle from behind instead of flying on top of the vehicle.

Referring now to FIG. 4, a method for controlling a UAV for charging is shown. In some embodiments, the steps shown in FIG. 4 may be performed by one or more processor-based devices, such as the UAV 110 and the host vehicle 120 described with reference to FIG. 1, the UAV 210 and the host vehicle 220 described with reference to FIG. 2, and/or other similar devices. In some embodiments, the steps may be performed by one or more of a processor of an autonomous aerial vehicle, an unmanned aerial vehicle, an autonomous ground vehicle, an unmanned ground vehicle, a processor of a host vehicle, a processor of a charging station, and/or a processor device of a server system. In some embodiments, one or more steps in FIG. 4 may be performed collectively by a plurality of UAVs and/or ground vehicles through distributed computing.

In step 401, the UAV operates based on independent flying procedures. In some embodiments, in an independent flying procedure, a UAV uses its sensors to navigate and performs tasks autonomously. In step 402, the system determines an escort buffer zone. The escort buffer generally refers to an area of clearance in which a UAV needs to fly near a host vehicle. In step 403, the system assesses the dimension of the UAV. The system may perform step 403 using optical sensors or using a vehicle identifier and/or carried package information. In step 404, the system assesses truck dimensions. A truck as described with reference to FIG. 4 may refer to a host vehicle. A truck's dimension may be determined using optical sensors on the UAV and/or be provided by the truck. In step 405, the system assesses the presence and locations of other UAVs escorting the truck. In step 406, the system assesses UAV performance, speed agility, stopping time, and load modifier. In some embodiments, the characteristics of the UAV assessed in step 406 may be determined based on a UAV database and/or the UAV's model specification. In some embodiments, a delivery information database may store package information and/or information on UAVs assigned to carry the packages.

In step 407, the system assesses a buffer profile using UAV energy maneuverability. In some embodiments, a UAV's performance may be assessed by the equation: PS=V((T−D)/W) where PS represents performance at speed, V represents velocity, T represents thrust, D represents Drag, and W represents weight. In some embodiments, the buffer zone is calculated to give room for the UAV to stop and/or maneuver around potential hazards/obstacles. In step 408, the system modifies the buffer to address the drag on the external payload (e.g. box, package) carried by the UAV. In some embodiments, the drag calculations may be based on D=Cd*A*0.5*r*V\hat{ }2 where D represents drag, Cd represents draft Coefficient, A represents reference area, r represents density, and V represents velocity.

In step 409, the system determines whether sufficient space is available around the truck based on the buffer profile determines in steps 407 and 408. If sufficient space is not available, the UAV returns to operating under the independent flying procedure in step 416. If a space meeting the buffer profile is available, in step 410, the system selects a space for the UAV. In step 411, the UAV works into the space at a pace that allows other UAVs to adjust around it. In step 412, the system assesses obstacles via sensors, truck dimensions, and trajectory. In step 413, the system modifies velocity of the UAV based on the equation V=min (a, b, c) wherein a represents the fastest safe speed, b represents the fastest allowed speed, and c represents the speed of the truck. In step 414, the UAV communicates the x, y, and z coordinates to other devices in the system with a timestamp (T). In step 415, the system determines whether the UAV's departure point has been reached and/or whether escort should be terminated for other reasons. If termination conditions are met, the UAV returns to independent flying procedures in step 416. If termination conditions are not yet met, the system returns to step 402 and continuously evaluates whether sufficient buffer zone(s) is present for escorting the truck to receive electrical charge.

The steps and equations in FIG. 4 are generally provided as examples only. A UAV and/or a host vehicle may determine whether a UAV can safely approach a host vehicle to charge and/or determine a charge position for the UAV based on other steps, factors, and equations. Similar steps may be performed to assess whether a UAV approach for over-the-air charging and direct contact charging. In some embodiments, direct contact charge may require a larger buffer zone as compared to over-the-air charging.

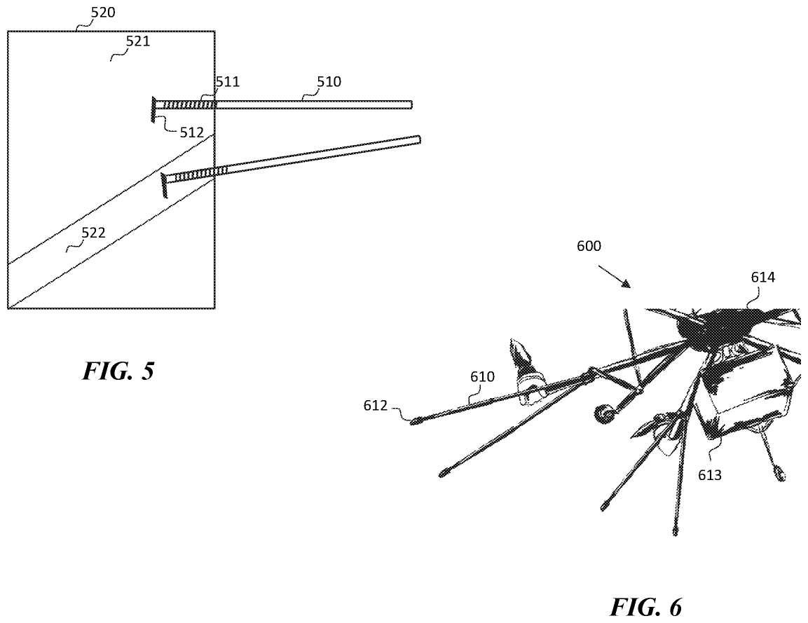

Referring now to FIG. 5, an illustration of a contact charge surface and charging antennas is shown. The contact charge surface 520 may generally be on a host vehicle such as host vehicle 120 and the host vehicle 220 described with reference to FIGS. 1 and 2 herein or similar devices. In some embodiments, the contact charge surface 520 may be implemented on a stationary charger device. The contact charge surface 520 comprises a positive region 522 and a negative region 521. The two regions provide a voltage differential configured to supply power to a UAV via the contact charge tips 512 of the charging antennas 510. In some embodiments, a wireless charging device (e.g. inductive coil) may be positioned behind the wireless charge surface to provide wireless charging. In some embodiments, the positive region 522 or the negative region 521 may be an exposed portion the wireless charger coil.

The charging antenna 510 may generally extend from a body of a UAV (not shown) traveling near the host vehicle. In FIG. 5, a set of charging antennas 510 makes contact with the positive region 522 and the negative region 521 of the contact charge surface 520. Each charging antenna comprises a wireless charge receiver portion 511 and a contact charge tip 512. When the contact charge tips 512 make direct contact with the contact charge surface 520, power is supplied to the UAV via direct contact charging. The wireless charge receiver 511 is configured to receive over-the-air power from a wireless charger on the host vehicle. In some embodiments, the wireless charge receiver 511 may receive power when the contact charge tips 512 are not in direct contact with the contact charge surface 520. In some embodiments, the wireless charge receiver 511 may continue to receive charge while the contact charge tip is in direct contact with the contact charge surface 520.

Referring now to FIG. 6, an illustration of a UAV is shown. The UAV 600 comprises a UAV body 614 and a charging antenna having a wireless charge receiver 610 and a contact charge tip 612. The charging antenna is shown to extend away from the body of the UAV beyond the wingspan of the rotors. The UAV 600 in FIG. 6 is shown to have at least two pairs of charging antennas and carrying a package 613. In some embodiments, the package may be attached to the UAV via an aerial crane, a package hook, a clamp, a magnet, and the like.

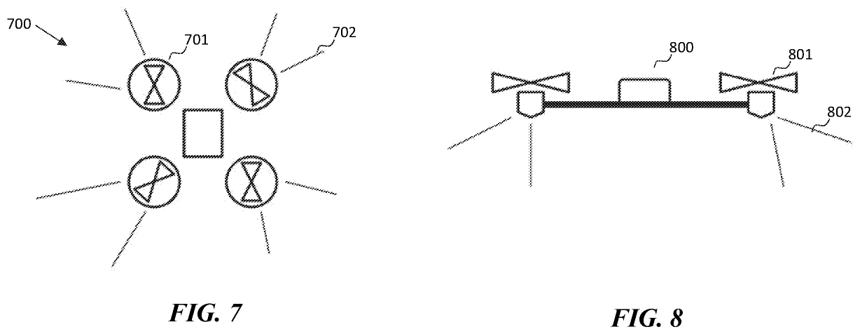

Referring now to FIG. 7 and FIG. 8, illustrations of UAVs with charging antennas are shown. In FIG. 7, a top view of a UAV 700 is shown. The UAV 700 comprises a body and four rotors 701. Four sets of charging antennas 702 extend away from the body of the UAV below the rotors 701. The tips of the charging antennas are spaced apart horizontally. In FIG. 8, a side view of a UAV 800 is shown. The UAV 800 comprises a body, rotors 801, and charging antennas 802 extending below and away from the rotors of the UAV.

FIGS. 5-8 are provided as examples only. Charging antennas 802 may be variously configured, oriented, and positioned on a UAV without departing from the spirit of the present disclosure.

UAVs can be simultaneously deployed from a truck to make individual deliveries of packages. Taking off and landing on trucks, however, can increase the risk of damage to the UAV and packages. UAVs can also take up truck space that could otherwise be used to store packages. UAV trailers offer a potential solution to the space problem, but trailers introduce their own challenges by lengthening a delivery truck and limiting the ease by which a delivery truck could, for example, pull into a driveway for a delivery and back out.

In some embodiments, a truck may be configured to provide wireless in-flight recharging of the UAVs while bringing UAVs to a deployment location. In some embodiments, UAVs may shadow a truck like a pilot fish shadow a shark, staying in lockstep, but never actually touching. Like a pilot fish leaving its shark to snag a scrap and then returning, UAVs would leave their truck to make their assigned delivery and then return for the escort home or to pick up another package for a delivery on that mission. In some embodiments, each UAVs may be programmed with two rules: avoid obstacles and stay within (or return to) the perimeter of the recharging current. In some embodiments, an escorting UAV may autonomously retrieve and deliver packages on a truck. In some embodiments, a UAV includes sensors that allow it to maneuver around the truck or temporarily leave the truck altogether in order to avoid obstacles such as a low-hanging branch or a bridge overpass.

In some embodiments, UAVs used in a store or distribution center may similarly receive power through wireless and contact charging. Wireless and hover contact charging may allow UAVs to operate continuously without needing to land and charge.

In some embodiments, UAVs are charged while airborne via electric coils and generators on a truck or in a store/distribution center. In some embodiments, a truck may include solar power panels or wind power generators to supply power to the UAV chargers. In some embodiments, a UAV assigned to a truck swarms near the truck to receives power over the air via electrical coils on the truck and does not land on the truck. In some embodiments, UAVs, like a flock of birds, may follow two simple rules: 1) do not hit a UAV or other object and 2) stay close enough to the truck to receive power. Rule one may overrule rule two, allowing the UAV to break away temporarily to avoid a collision before returning to the recharging range. In some embodiments, a truck may be a dedicated charger vehicle configured to supply power to UAVs that swarms around it. In some embodiments, the truck may also carry packages that could be picked up by UAVs for multiple deliveries during one truck trip. In some embodiments, UAVs may receive and retain charge from electricity generated by the coils on the truck while swarming and use their stored power during the delivery missions away from the truck. In some embodiments, UAVs in a swarm may be connected by distributed logic so that they act as one and respond as one to threats following the simple rules to first not hit objects and second stay within recharging range of the truck. In some embodiments, the UAVs may be programmed to respond to failure by breaking from the swarm, landing to the side of a road, and sounding an alert to be picked up. In some embodiments, UAVs swarming around a dedicated swarm truck may be simultaneously deployed to deliver packages in a neighborhood at the same time. In some embodiments, UAVs tasks and autonomous truck routes may be used to determine when a UAV should leave or return to the truck. For example, a UAV may time its departure for delivery such that the truck is close to the UAV's location at the completion of the delivery. In some embodiments, UAV rotors may be enclosed so that UAVs in a swarm do not clip each other's rotors. In some embodiments, if conditions allow, a UAV may temporarily land to save energy while other UAVs continue to fly in the swarm. In some embodiments, if the charger coil fails, the truck may be driven to a suitable spot and the UAVs may receive a command to land nearby. In some embodiments, UAVs may be launched on short ad hoc missions, for example, spy hop to see what is causing traffic up ahead. In some embodiments, UAVs may communicate with one another so that if a UAV has a problem, the mission can still be completed by another UAV.

In some embodiments, one or more of the embodiments include one or more localized IoT devices and controllers. For example, one or more of the UAVs and the host vehicles systems may form an IoT network. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KM includes a continuously utilized near-term source of data, but KM may be discarded depending upon the degree to which such KM has any value based on local processing and evaluation of such KM. In an exemplary embodiment, KM may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near-term source of data, but KRN may be retained in order to provide a predictive model of noisy data.

In some embodiments, a system for charging a package delivery unmanned aerial vehicle (UAV) in flight comprises a body of a UAV, a power storage device, a locomotion system, a communication device configured to communicate with host vehicles, a charging antenna coupled to and extending away from the body of the UAV, the charging antenna comprises a wireless charge receiver positioned along a length of the charging antenna and a contact charge tip positioned at an end of the charging antenna away from the body, and a control circuit of the UAV coupled to the locomotion system and the communication device. The control circuit being configured to establish communication with a host vehicle having a wireless charger and a contact charge surface, drive the locomotion system to hover near the wireless charger of the host vehicle to charge the power storage device via the charging antenna of the charging antenna, detecting for a travel condition with a sensor system, determine whether the travel condition meets a contact charge condition based on the communication with the host vehicle, and in the event that the travel condition meets the contact charge condition, drive the locomotion system to cause the contact charge tip of the charging antenna to contact the contact charge surface of the host vehicle to charge the power storage device while hovering.

In some embodiments, A method for charging a package delivery unmanned aerial vehicle (UAV) in flight comprises controlling, with a control circuit of a UAV, motions of the UAV via a locomotion system, wherein the UAV comprises a charging antenna coupled to and extending away from a body of the UAV, the charging antenna comprises a wireless charge receiver positioned along a length of the charging antenna and a contact charge tip positioned at an end of the charging antenna away from the body, establishing, via a communication device coupled to the control circuit, communication with a host vehicle having a wireless charger and a contact charge surface, driving the locomotion system to hover near the wireless charger of the host vehicle to charge a power storage device of the UAV via the charging antenna of the charging antenna, detecting, with a sensor system, the travel condition, determining, with the control circuit, whether the travel condition meets a contact charge condition based on the communication with the host vehicle, and in the event that the travel condition meets the contact charge condition, driving the locomotion system to cause the contact charge tip of the charging antenna to contact the contact charge surface of the host vehicle to charge the power storage device while hovering.

In some embodiments, a system for charging an unmanned aerial vehicle (UAV) in flight with a vehicle comprises a vehicle body, wireless charger configured to transfer power wirelessly to a UAV through a wireless charge receiver positioned along a length of a charging antenna extending from a body of the UAV, a contact charge surface on an exterior of the vehicle body, the contact charge surface being configured to supply power to the UAV through direct electrical contact with a contact charge tip of the charging antenna of the UAV positioned at an end of the charging antenna away from the body of the UAV, a communication device configured to communicate with a plurality of UAVs near the vehicle, a sensor system configured to detect travel condition, and a control circuit coupled to the sensor system and the communication device. The control circuit being configured to detect, with the sensor system, a presence of the UAV near the vehicle, establish communication with the UAV via the communication device, provide wireless charging to the UAV via the wireless charger, determine whether the travel condition meets a contact charge condition, and in the event that the travel condition meets the contact charge condition, instruct the UAV to contact the contact charge surface to charge the UAV.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for charging a package delivery unmanned aerial vehicle (UAV) in flight, the system comprises:
a body of a UAV;
a power storage device;
a locomotion system;
a communication device configured to communicate with host vehicles;
a charging antenna coupled to and extending away from the body of the UAV, the charging antenna comprises a wireless charge receiver positioned along a length of the charging antenna and a contact charge tip positioned at an end of the charging antenna away from the body; and
a control circuit of the UAV coupled to the locomotion system and the communication device, the control circuit being configured to:
establish communication with a host vehicle having a wireless charger and a contact charge surface;
drive the locomotion system to hover near the wireless charger of the host vehicle to charge the power storage device via the charging antenna of the charging antenna;
detecting for a travel condition with a sensor system;
determine whether the travel condition meets a contact charge condition based on the communication with the host vehicle; and
in the event that the travel condition meets the contact charge condition, drive the locomotion system to cause the contact charge tip of the charging antenna to contact the contact charge surface of the host vehicle to charge the power storage device while hovering.

2. The system of claim 1, wherein the charging antenna comprises a flexible rod.

3. The system of claim 1, wherein the charging antenna is configured to be extended and retracted by the control circuit.

4. The system of claim 1, wherein the contact charge tip comprises a metal brush.

5. The system of claim 1, wherein the contact charge tip comprises two spaced apart prongs.

6. The system of claim 1, wherein the host vehicle comprises the sensor system for detecting the travel condition of the UAV and/or the host vehicle and communicates the travel condition to the control circuit of the UAV.

7. The system of claim 1, wherein the host vehicle is configured to provide flight instructions to the locomotion system of the UAV via the communication device and the control circuit.

8. The system of claim 1, wherein the sensor system comprises one or more onboard sensors of the UAV.

9. The system of claim 1, wherein whether the travel condition meets the contact charge condition is determined based on one or more of host vehicle speed, host vehicle path, clearance around the host vehicle, current drag, UAV speed, UAV acceleration capability, and UAV cargo weight.

10. The system of claim 1, wherein the control circuit is further configured to:
determine whether the travel condition meets the contact charge condition while the contact charge tip of the charging antenna is in contact with the contact charge surface of the host vehicle; and
in the event that travel condition does not meet the contact charge condition, cause to the locomotion system to move the charging antenna away from the contact charge surface of the host vehicle.

11. A method for charging a package delivery unmanned aerial vehicle (UAV) in flight, the method comprises:
controlling, with a control circuit of a UAV, motions of the UAV via a locomotion system, wherein the UAV comprises a charging antenna coupled to and extending away from a body of the UAV, the charging antenna comprises a wireless charge receiver positioned along a length of the charging antenna and a contact charge tip positioned at an end of the charging antenna away from the body;
establishing, via a communication device coupled to the control circuit, communication with a host vehicle having a wireless charger and a contact charge surface;
driving the locomotion system to hover near the wireless charger of the host vehicle to charge a power storage device of the UAV via the charging antenna of the charging antenna;
detecting, with a sensor system, the travel condition;
determining, with the control circuit, whether the travel condition meets a contact charge condition based on the communication with the host vehicle; and
in the event that the travel condition meets the contact charge condition, driving the locomotion system to cause the contact charge tip of the charging antenna to contact the contact charge surface of the host vehicle to charge the power storage device while hovering.

12. The method of claim 11, wherein the host vehicle comprises a sensor system for detecting the travel condition of the UAV and/or the host vehicle and communicates the travel condition to the control circuit of the UAV.

13. The method of claim 11, wherein the host vehicle is configured to provide flight instructions to the locomotion system of the UAV via the communication device and the control circuit.

14. The method of claim 11, wherein the sensor system comprises one or more onboard sensors of the UAV.

15. The method of claim 11, wherein whether the travel condition meets the contact charge condition is determined based on one or more of host vehicle speed, host vehicle path, clearance around the host vehicle, current drag, UAV speed, UAV acceleration capability, and UAV cargo weight.

16. The method of claim 11, further comprising:
determining whether the travel condition meets the contact charge condition while the contact charge tip of the charging antenna is in contact with the contact charge surface of the host vehicle; and
in the event that travel condition does not meet the contact charge condition, causing to the locomotion system to move the charging antenna away from the contact charge surface of the host vehicle.

17. A system for charging an unmanned aerial vehicle (UAV) in flight with a vehicle, the system comprises:
a vehicle body;
a wireless charger configured to transfer power wirelessly to a UAV through a wireless charge receiver positioned along a length of a charging antenna extending from a body of the UAV;
a contact charge surface on an exterior of the vehicle body, the contact charge surface being configured to supply power to the UAV through direct electrical contact with a contact charge tip of the charging antenna of the UAV positioned at an end of the charging antenna away from the body of the UAV;
a communication device configured to communicate with a plurality of UAVs near the vehicle;
a sensor system configured to detect travel condition; and
a control circuit coupled to the sensor system and the communication device, the control circuit being configured to:
detect, with the sensor system, a presence of the UAV near the vehicle;
establish communication with the UAV via the communication device;
provide wireless charging to the UAV via the wireless charger;
determine whether the travel condition meets a contact charge condition; and
in the event that the travel condition meets the contact charge condition, instruct the UAV to contact the contact charge surface to charge the UAV.

18. The system of claim 17, wherein the contact charge surface comprises a portion of an induction coil of the wireless charger.

19. The system of claim 17, wherein power is supplied to the contact charge surface only when at least one UAV has been instructed to contact the contact charge surface.

20. The system of claim 17, wherein the control circuit is further configured to control the UAV while the UAV is being charged by the vehicle.
